(19) United States
(12) Patent Application Publication
(10) Pub. No.: US 2026/0125858 A1
(43) Pub. Date: May 7, 2026

(54) ARTIFICIAL TURF WITH TRACTION CONTROL AGENT

(71) Applicants: Polytex Sportbelage Produktions-GmbH, Grefrath (DE); Synthetic Turf Resources, Dalton, GA (US)

(72) Inventors: Stephan SICK, Baden-Baden (DE); Dario GROCHLA, Bochum (DE); Anthony David DANIELL, Dalton, GA (US)

(73) Assignees: Polytex Sportbelage Produktions-GmbH, Grefrath (DE); Synthetic Turf Resources, Dalton, GA (US)

(21) Appl. No.: 18/949,257

(22) Filed: Nov. 15, 2024

(30) Foreign Application Priority Data
Nov. 7, 2024 (EP) 24211495.7
Nov. 7, 2024 (EP) 24211496.5

(51) Int. Cl. E01C 13/08; B29C 48/00; B29C 48/05; B29K 23/00; B29K 67/00; B29K 77/00; B29K 105/00; B29L 31/00; D01F 6/90; D01F 6/92

(52) U.S. Cl. CPC E01C 13/08; B29C 48/022; B29C 48/05; D01F 6/90; D01F 6/92; B29K 2023/0633; B29K 2067/00; B29K 2077/00; B29K 2105/0005; B29K 2105/0088; B29L 2031/731; D10B 2321/021; D10B 2331/02; D10B 2331/04; D10B 2505/202

(57) ABSTRACT

Disclosed is an artificial turf fiber comprising:
1.0 to 10.0 wt % of the fiber a modifier polymer material,
the remainder of the fiber including a base polymer material and at least one additive,
wherein the modifier polymer material is polyethylene selected from an ultra-low density polyethylene (ULDPE) or a low density polyethylene (LDPE) or a combination thereof,
wherein the base polymer material is polyamide, or polyester, or a combination thereof, and
wherein the at least one additive includes a compatibilizer.

### FIELD OF THE INVENTION

The invention relates generally to the field of artificial turf and, more particularly, to an artificial turf fiber that is especially suitable for outdoor sport and recreational venues in hot climates and a method for making the same.

### BACKGROUND

Artificial turf fibers are often made entirely or predominantly from polyethylene (PE) due to its smoothness, elasticity, and relatively low cost compared to other polymers. However, in hot climate regions, artificial turf fibers made from polyamide (PA) are sometimes preferred because they are more resistant to environmental heat, as PA fibers generally have higher melting points than PE fibers. Typically, polyamides such as PA6 or PA6,6 (also known as Nylon 6 and Nylon 6,6) have melting points between 190° C. and 350° C., while PE has a melting point between 115° C. and 135° C. However, PA fibers tend to be more brittle and may feel less comfortable underfoot than PE fibers due to their greater toughness and stiffness. Additionally, PA fibers can retain more heat from sunlight, particularly in warmer climates, which may lead to discomfort for users. PA fibers may also absorb more moisture than PE fibers, resulting in longer drying times after rain or field irrigation.

Artificial turf fibers made from polymer blends, such as PE and PA, have been discussed in the patent literature. For example, patent documents CN110777605A, JPH09268514A, CN117801413A, EP3122942 B1, and CN117801413A describe artificial turfs comprising mixtures of PA and PE polymers.

Patent document KR102154131B1 describes a method for manufacturing artificial turf fibers with a marble color pattern by preparing a polymer mixture using polymers such as PA, polyethylene terephthalate, and polybutylene terephthalate, combined with a base polymer of PE or polyester (PET), with the base polymer comprising 70 to 90 wt % of the polymer mixture.

For instance, CN117801413A describes the use of linear low-density polyethylene (LLDPE) in small amounts with PA, along with a compatibilizer of PE grafted with maleic anhydride (PE-g-MA). Additionally, JP H09268514A describes the use of high-density polyethylene (HDPE) in small amounts with PA and PE-g-MA as a compatibilizer.

These patent documents generally describe using large amounts of PE in the polymer blend and/or combinations of specific polymer grades and compatibilizers that may result in artificial turf fibers that are too soft, insufficiently resistant to high temperatures, or prone to faster wear compared to pure PA or PE fibers.

A common issue with artificial turf fibers made from PE and PA polymer blends is delamination, where the fibers separate at the interface between PE and PA polymers. This delamination can reduce the lifespan of artificial turf installations using such fibers.

### SUMMARY OF THE INVENTION

Specifically, a three-phase polymer fiber, an artificial turf using said three-phase polymer fiber, and a method of manufacturing the three-phase artificial turf fiber and the artificial turf using said three-phase polymer fiber as specified in the independent claims. Embodiments are given in the dependent claims. Embodiments and examples disclosed herein can freely be combined with each other if they are not mutually exclusive.

Embodiments of the invention may overcome or ameliorate at least some of the limitations of the prior art.

Embodiments of the artificial turf fiber descried herein may exhibit an improved balance of heat resistance, wear resistance, resilience, softness, and other performance characteristics making it particularly suitable for applications such as sport fields, in particular outdoor sport fields, and recreational parks in hot climate regions of the world.

According to embodiments, the artificial turf fiber mainly consists of polyamide (PA) and/or polyester (PET), and a small amount of ULDPE and/or LDPE, whereby the ULDPE and/or LDPE is comprised in the form of thread-like regions within a continuous PA or PET phase. The ULDPE and/or LDPE polymer which is used in a small amount may be referred to hereinafter as the modifier polymer. The PA polymer or the PET polymer which is used in a large amount may be referred to hereinafter as the base polymer.

It has been discovered, rather unexpectedly, that combining a small amount of ULDPE (and/or LDPE) (the modifier polymer) with a large amount of PA or PET (the base polymer) and a suitable compatibilizer, then the ULDPE/LDPE forms thread-like structures surrounded by the compatibilizer within a PA or a PET continuous phase. The ULDPE/LDPE thread-like structures provide PA or PET based fibers with an improved balance of heat resistance, resilience and softness compared to existing grades. The fibers are less brittle, free of delamination, and markedly more robust and wear resistant in hot climates than fibers made from PA alone or mixtures of PA with linear low density polyethylene (LLDPE) or with high density polyethylene (HDPE).

The bonding of the ULDPE/LDPE thread-like regions with the PA or PET main continuous phase is rather very strong resulting in a fiber that is adequately heat resistant for very hot climate applications, but also has exceptional delamination and wear resistance. Although not wishing to be bound by theory it is postulated that the structural characteristics of the ULDPE and the LDPE, i.e., the highly branched and non-linear structure of these two polymers compared to the more regular, less branched, linear structures of LLDPE and HDPE, not only increases the overall tensile strength of the fiber but also provides a strong synergistic effect with the base polymer PA or PET polymer, and the selected compatibilizer. In particular, the high degree of branching of ULDPE and LDPE (compared to e.g. LLDPE) has observed to prevent fiber splicing (splitting the fiber in longitudinal direction).

According to a first aspect of the present invention an artificial turf fiber comprises a modifier polymer material by 1.0 to 10.0 wt % of the fiber, the remainder of the fiber including a base polymer material and at least one additive, wherein the modifier polymer material is a polyethylene selected from an ultra-low density polyethylene (ULDPE) or a low density polyethylene (LDPE) or a combination thereof, wherein the base polymer material is polyamide (PA), or polyester (PET), and wherein the at least one additive includes a compatibilizer.

The compatibilizer forms a boundary layer between the modifier polymer material and the base polymer material, and the modifier polymer material forms elongated thread-like structures inside a continuous phase of the base polymer material.

In some embodiments, the remainder of the fiber consists of the base polymer material and the at least one additive.

According to some embodiments, the compatibilizer is any one of the following: a maleic acid grafted on polyethylene or polyamide; a maleic anhydride grafted on free radical initiated graft copolymer of polyethylene, SEBS, EVA, EPD, or polypropylene with an unsaturated acid or its anhydride such as maleic acid, glycidyl methacrylate, ricinoloxazoline maleinate; a graft copolymer of SEBS with glycidyl methacrylate, a graft copolymer of EVA with mercaptoacetic acid and maleic anhydride; a graft copolymer of EPDM with maleic anhydride; a graft copolymer of polypropylene with maleic anhydride; a polyolefin-graft-polyamide; a polyolefin-graft-polyethylene; a polyolefin-graft-polyamide; a polyacrylic acid type compatibilizer; a polyethylene grafted with maleic anhydride; and ethylene ethyl acrylate, EEA.

The compatibilizer may in particular include ethylene ethyl acrylate (EEA), a polyethylene grafted with maleic anhydride (PE-g-MA) or a combination of PE-g-MA and EEA. The compatibilizer preferably includes ethylene ethyl acrylate (EEA).

Preferably, the polyethylene grafted with the maleic anhydride is ULDPE or LDPE, and more preferably is the same as the polyethylene that is the modifier polymer material. Hence, in an example, the modifier polymer may be ULDPE, and the PE in the PE-g-MA compatibilizer may also be ULDPE. In another example, the modifier polymer is LDPE, and the PE in the PE-g-MA compatibilizer may also be LDPE.

In some embodiments, the artificial turf fiber may comprise 2.0 to 9.0 wt %, or 2.0 to 8.0 wt %, or 2.0 to 7.0 wt %, or 3.0 to 7.0 wt % of the modifier polymer material.

In some embodiments, the modifier polymer material is ULDPE, and the base polymer material is PA or PET.

In some embodiments, the modifier polymer material is ULDPE.

The PA used as or comprised in the base polymer may be, for example, PA6, PA66, PA11, PA12, PA46, PA610 and PA612.

The PET used as or comprised in the base polymer may be, for example, a polyester homopolymer with a melting point of 160 to 170° C. The molecular weights and melt flow rate (MFR) of the modifier polymer and of the base polymer may vary.

In some embodiments, the ULDPE and the LDPE may have an average molecular weight of from 50,000 to 300,000 g/mol, or 75,000 to 275,000 g/mol, or 100,000 to 250,000 g/mol and an MFR from 5.0 to 20 g/10 min, or 5.0 to 15.0 g/10 min.

In addition, or alternatively, the PA may have an average molecular weight from 20,000 to 40,000 g/mol, or 25,000 to 40,000 g/mol, or 30,000 to 40,000 g/mol, and an MFR OF 3.0 to 20 g/10 min, or 3.0 to 10 g/10 min.

In addition, or alternatively, the PET may have an average molecular weight from 200,000 to 400,000 g/mol, or 250,000 to 400,000 g/mol, or 300,000 to 400,000 g/mol, and an MFR OF 2.0 to 10 g/10 min, or 2.0 to 5 g/10 min.

The average molecular weight may be measured according with GPC according to ASTM D6474 or ISO 16014 and the MFR may be measured according to ASTM D1238 or ISO 1133.

In some embodiments the compatibilizer is polyethylene grafted with maleic anhydride having a a melting point of 105° C.-135° C., e.g., 120° C., as measured by ASTM D3418 or ISO 3146, a crystallization point of 90° C.-110° C., e.g., 102° C., as measured by ASTM D3418, or ISO 3146, a cat softening point of 90° C.-100° C., e.g., 95° C., as measured by ASTM D1525 or ISO 306, a density of 0.80 g/cm3 to 1.00 g/cm3, e.g., 0.93 g/cm3, as measured by ASTM D792 or ISO 1183, and a melt flow index of 1.0-5.0, e.g., 1.75 g/10 min (190° C./2.16 kg), as measured by ASTM D1238 or ISO 1133.

According to preferred embodiments, a weight percent ratio of the compatibilizer to the modifier polymer material is 2 to 30, or 7 to 30, or 5 to 20.

This ratio has been observed to be particularly effective in preventing delamination of the fiber.

The thread-like structures may have a diameter less than 50 micrometers, or less than 10 micrometers, or less than 1 micrometers. The thread-like structures may have a length of less than 2 mm.

The term ‘polymer domain or ‘beads’ may refer to a localized region, such as a droplet, of a polymer that is immiscible in the second polymer. The polymer beads may in some instances be round or spherical or oval-shaped, but they may also be irregularly-shaped. In some instances the polymer domain will typically have a size of approximately 0.1 to 3 micrometer, preferably 1 to 2 micrometer in diameter. In other examples the polymer domains will be larger. They may for instance have a size with a diameter of a maximum of 50 micrometer.

In a further aspect of the present invention, described herein is an artificial turf fiber comprising:
a modifier polymer material in an amount of 1.0 to 10.0% by weight of the fiber,
the remainder of the fiber including a base polymer material and at least one additive, wherein the modifier polymer material is linear low density polyethylene, LLDPE, and wherein the base polymer material is polyester, and
   wherein the at least one additive includes a compatibilizer.

Accordingly, also described herein is a method of manufacturing an artificial turf fiber (901), the method comprising the steps of:
creating (100) a polymer mixture (100, 400, 500), the polymer mixture comprising 1.0 to 10.0% by its weight a modifier polymer material (402), the remainder of the polymer mixture including a base polymer material (404) and at least one additive, wherein the modifier polymer material is linear low density polyethylene, LLDPE, wherein the base polymer material is polyester, wherein the at least one additive includes a compatibilizer (406), wherein the polymer mixture comprises domains of the modifier polymer material;
extruding (102) the polymer mixture into a monofilament (606);
quenching (104) the monofilament (606);
reheating (106) the monofilament (606); and
stretching (108) the reheated monofilament to reshape the domains of the modifier polymer into threadlike structures (800) and to form the monofilament into an artificial turf fiber (901).

According to another aspect of the present invention, an artificial turf is provided which comprises an artificial turf backing, and the inventive artificial turf fiber as described incorporated into the artificial turf backing.

In yet another aspect of the present invention, a method of manufacturing the inventive artificial turf fiber is provided, the method comprising the steps of:
creating a polymer mixture comprising 1.0 to 10.0 wt % of a modifier polymer material, the remainder of the polymer mixture including a base polymer material and at least one additive, wherein the modifier polymer material is polyethylene selected from an ultra-low density polyethylene (ULDPE) or a low density polyethylene (LDPE) or a combination thereof, wherein the base polymer material is polyamide (PA), or polyester (PET), or a blend of two or more of the PA and PET, and wherein the at least one additive includes a compatibilizer;
extruding the polymer mixture into a monofilament;
quenching the monofilament;
reheating the monofilament; and
stretching the reheated monofilament to reshape the polymer domains made of the modifier polymer material into threadlike structures and to form the monofilament into an artificial turf fiber.

The compatibilizer employed in the method may comprise EEA, or a combination of EEA and PE-g-MA. The modifier polymer material and the base polymer material are immiscible and the modifier polymer material forms polymer domains surrounded by the compatibilizer within a continuous phase of the base polymer material. The polymer domains comprise crystalline fractions and amorphous fractions, and the stretching of the polymer domains into thread-like structures my cause an increase in the size of the crystalline fractions relative to the amorphous fractions.

Forming the polymer mixture may comprise forming a first mixture by mixing the modifier polymer material with the compatibilizer, and then heating and extruding the first mixture. The extruded first mixture may then be granulated. The granulated first mixture may then be mixed and heated with the base polymer material to form the polymer mixture.

The inventive artificial turf fiber may be incorporated into an artificial turf backing to form an artificial turf.

It is understood that one or more of the described examples may be combined as long as the combined examples are not mutually exclusive.

### BRIEF DESCRIPTION OF THE DRAWINGS

In the following, examples are described in greater detail by referring to the drawings in which:

FIG. 1 shows a flowchart which illustrates an example of a method of manufacturing the artificial turf fiber;

FIG. 2 shows a flowchart which illustrates one method of creating the polymer mixture;

FIG. 3 shows a flowchart which illustrates a further example of how to create a polymer mixture;

FIG. 4 shows a diagram which illustrates a cross-section of a polymer mixture;

FIG. 5 shows a further example of a polymer mixture;

FIG. 6 illustrates the extrusion of the polymer mixture into a monofilament;

FIG. 7 shows a cross-section of a small segment of the monofilament;

FIG. 8 illustrates the effect of stretching the monofilament;

FIG. 9 shows an example of a cross-section of an example of artificial turf system.

### DETAILED DESCRIPTION

In the following, similar elements are denoted by the same reference numerals. Elements which have been discussed previously will not necessarily be discussed in later figures if the function is equivalent.

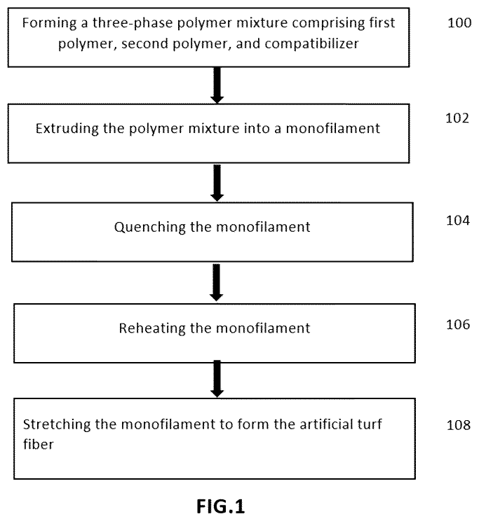

FIG. 1 is a flowchart of a method of manufacturing an artificial turf fiber according to some embodiments of the present invention. First, according to step 100 a polymer mixture is created. The polymer mixture is a three-phase system. The polymer mixture comprises a modifier polymer, a base polymer, and a compatibilizer. The modifier polymer may be ULDPE and/or LDPE and the base polymer may be PA and/or PET. The modifier polymer and the base polymer are immiscible. The compatibilizer may be EEA, PE-g-MA, or a mixture of EEA and PE-g-MA. The modifier polymer forms polymer domains surrounded by the compatibilizer. The polymer domains may also be formed by additional polymers which are not miscible in the base polymer.

The polymer domains are surrounded by the compatibilizer and are dispersed within the base polymer. In the next step 102 the polymer mixture is extruded into a monofilament. Next according to step 104 the monofilament is quenched or rapidly cooled down. Next according to step 106 the monofilament is reheated. According to step 108 the reheated monofilament is stretched to reshape the polymer domains into thread-like structures and to form the monofilament into the artificial turf fiber. Additional steps may also be performed on the monofilament to form the artificial turf fiber. For instance, the monofilament may be spun or woven into a yarn with desired properties. The artificial turf fiber may be incorporated into an artificial turf backing to form an artificial turf (Not shown). The incorporation of the artificial turf fiber into the artificial turf backing may be performed by any suitable method, including for example tufting, or weaving the artificial turf fiber into the artificial turf backing. To complete the artificial turf, the artificial turf fibers may be bound to the artificial turf backing. For instance, the artificial turf fibers may be secured to the backing by using a glue or an adhesive. Alternatively, the artificial turf fibers may be held in place by applying a coating or other material on a back side of the backing where a portion of the fibers may protrude. The securing step is an optional step since depending on the structure of the artificial turf it may not be needed. For example, if the artificial turf fibers are woven into the artificial turf backing the fibers may be adequately bound to the backing without the need for an additional step.

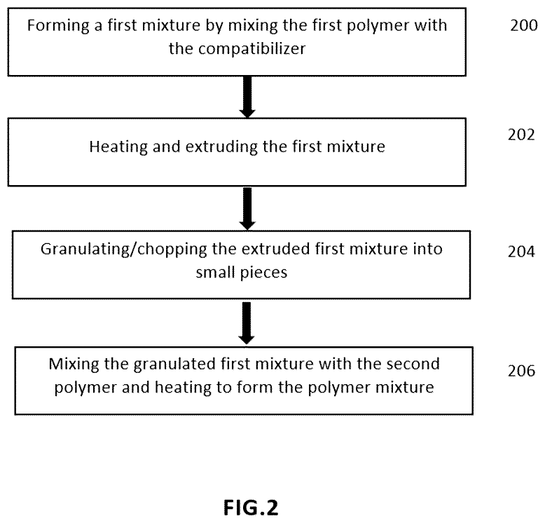

FIG. 2 is a flowchart of a method of creating the polymer mixture comprising the modifier polymer, the base polymer and the compatibilizer. The modifier polymer may be ULDPE and/or LDPE, the base polymer may be PA and or PET, and the compatibilizer may be EEA, a mixture of EEA and PE-g-MA. The polymer mixture may also comprise other materials such as color additives, UV resistant additives, flame-resistance additives, ani-bacterial additives, and additives for improving the flow characteristics of the polymer mixture. First, according to step 200, a first mixture is formed by mixing the modifier polymer with the compatibilizer. One or more additives may also be added during this step. Next, according to step 202, the first mixture is heated and extruded. Then, according to step 204, the extruded first mixture is granulated or chopped into small pieces. Next, according to step 206, the granulated first mixture is mixed with the base polymer and is heated with the base polymer to form the polymer mixture. Additional additives may also be added to the polymer mixture at this time. The heating and mixing may occur at the same time or at different times.

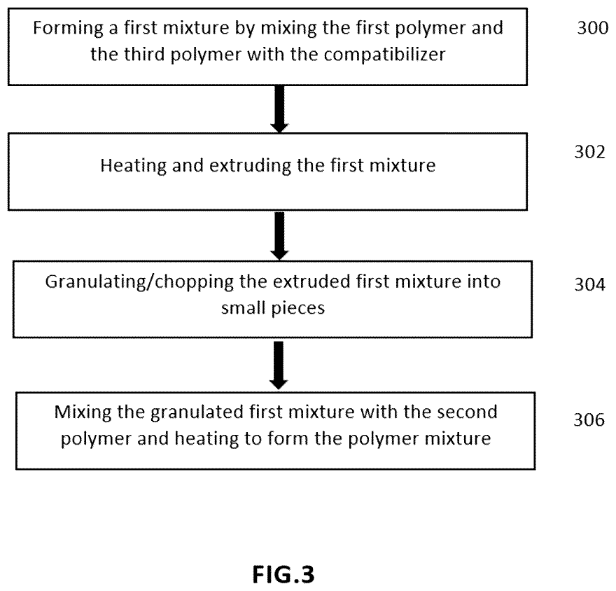

FIG. 3 shows a flowchart which illustrates a further example of how to create the polymer mixture of step 100 which is employed in the method of FIG. 1. In this example the polymer mixture comprises a modifier polymer ULDPE and/or LDPE, and a base polymer which comprises PA. The modifier polymer in some examples additionally comprises at least a second modifier polymer which is a PET homopolymer. The second modifier polymer is immiscible with the base polymer and the polymer mixture is at least a four-phase system. The second modifier polymer further forms the polymer domains surrounded by the compatibilizer with the base polymer. First, according to step 300 a first mixture is formed by mixing the first modifier polymer and the second modifier polymer with the compatibilizer. Additional additives may be added to the first mixture at this point. Next according to step 302 the first mixture is heated and extruded. In a variation of the method, the heating and the mixing steps of the first mixture may be done at the same time and may be followed by the extruding step 302.

Next according to step 304 the extruded first mixture is granulated or chopped into tiny pieces. Next according to step 306 the first mixture is mixed with the base polymer. Additional additives may be added to the polymer mixture at this time. Then finally according to step 308 the heated first mixture and the base polymer are heated to form the polymer mixture employed according to step 100 of the method of FIG. 1. The heating and the mixing may be done simultaneously.

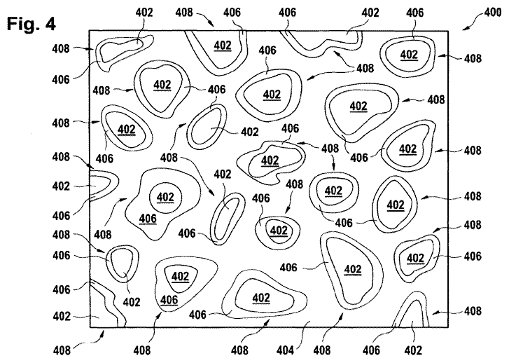

FIG. 4 shows a diagram which illustrates a cross-section of a polymer mixture 400 according to some embodiments of the present invention. The polymer mixture 400 comprises a modifier polymer 402, a base polymer 404, and a compatibilizer 406. The modifier polymer 402 is ULDPE and/or LDPE. The base polymer is PA or PET. The modifier polymer (i.e., ULDPE/LDPE) and the base polymer (i.e., PA or PET) are immiscible. The modifier polymer 402 is used in small amounts while the base polymer 404 forms most of the balance of the polymer mixture 400. For example, the ULDPE/LDPE 402 may be used in an amount of 1.0 to 10.0 wt %, or 2.0 to 9.0 wt %, or 2.0 to 8.0 wt %, or 2.0 to 7.0 wt %, or 3.0 to 7.0 wt % of the polymer mixture 400. The balance is mostly PA polymer or mostly PET and a compatibilizer 406. The compatibilizer 406 forms a boundary layer between the modifier polymer 402 and the base polymer 404. The compatibilizer 406 includes EEA, PE-g-MA, or a mixture of EEA and PE-g-MA. The PE in the backbone of the PE-G-MA is preferably ULDPE or LDPE. Preferably, the PE in the backbone of the PE-G-MA is ULDPE when the modifier polymer 402 is ULDPE, or the PE in the backbone of the PE-G-MA is LDPE when the modifier polymer 402 is LDPE.

In some embodiments, the modifier polymer 402 is ULDPE, the base polymer 404 is PA and the compatibilizer 406 is EEA. In another embodiment, the modifier polymer 402 is LDPE, the base polymer 404 is PA and the compatibilizer 406 is EEA.

In some embodiments, the modifier polymer 402 is ULDPE, the base polymer 404 is PA and the compatibilizer 406 is a mixture of EEA and PE-g-MA with the PE of the compatibilizer being ULDPE. In another embodiment, the modifier polymer 402 is LDPE, the base polymer 404 is PA and the compatibilizer 406 is a mixture of EEA and PE-g-MA with the PE of the compatibilizer being LDPE.

In some embodiments, the modifier polymer 402 is ULDPE, the base polymer 404 is PET and the compatibilizer 406 is EEA. In another embodiment, the modifier polymer 402 is LDPE, the base polymer 404 is PET and the compatibilizer 406 is EEA.

In some embodiments, the modifier polymer 402 is ULDPE, the base polymer 404 is PET and the compatibilizer 406 is a mixture of EEA and PE-g-MA with the PE of the compatibilizer being ULDPE. In another embodiment, the modifier polymer 402 is LDPE, the base polymer 404 is PA and the compatibilizer 406 is a mixture of EEA with PE-g-MA with the PE of the compatibilizer being LDPE.

Suitable PA polymer materials include PA6, PA66, PA11, PA12, PA46, PA610 and PA612.

The EEA may have an average molecular weight of 50000 to 300,000 g/mol, a composition of 50-70 wt % ethylene and 30-50 wt % ethyl acrylate, a Tg (glass transition temperature) of −30 to −40 C, and MFR of 5-25 g/10 minutes.

The PE-g-MA compatibilizer may be FUSABOND E226 available commercially by Dow. The FUSABOND E226 has a melting point of 120° C. as measured by ASTM D3418 or ISO 3146, a freezing point of 102° C. as measured by ASTM D3418, or ISO 3146, a cat softening point of 95° C. as measured by ASTM D1525 or ISO 306, a density of 0.93 g/cm3 as measured by ASTM D792 or ISO 1183, a melt flow index (190 C/2.16 Kg) as measured by ASTM D1238 or ISO 1133. The weight percent ratio of the compatibilizer (e.g., the EEA or the PE-g-MA) to the modifier polymer material (e.g., the LDPE and/or ULDPE) is 2 to 30, or 7 to 30, or 5 to 20.

In FIG. 4, the modifier polymer 402 is surrounded by the compatibilizer 406 and is dispersed within the base polymer 404 which forms a continuous phase. The modifier polymer 402 is surrounded by the compatibilizer 406 and forms a plurality of polymer domains 408. The shape of the polymer domains 408 may differ. For example, the polymer domains 408 may have a generally spherical, or oval shape. The polymer domains 408 may in some instances be irregularly-shaped depending upon how well the polymer mixture 400 is mixed and the temperature of the polymer mixture. The polymer mixture 400 is an example of a three-phase system. The first phase region is that of the modifier polymer 402. The second phase region is the compatibilizer 406 and the third phase region is the base polymer 404. The compatibilizer 406 separates the modifier polymer 402 from the base polymer 406. The modifier polymer may include ULDPE or LDPE or a mixture of ULDPE and LDPE. If a mixture of ULDPE and LDPE is used the polymer domains 408 will contain a mixture of the two because they are miscible to each other. The base polymer 406 may be PA, or PET as described above.

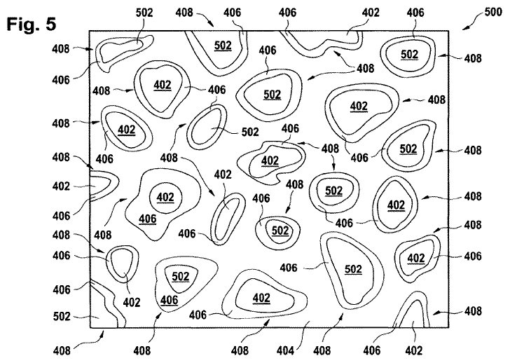

FIG. 5 shows a further example of a polymer mixture 500 according to some embodiments of the present invention. FIG. 5 illustrates that the polymer mixture 500 comprises a first dispersed polymer 402 which may be ULDPE or LDPE or a mixture of ULDPE and LDPE, a base polymer 404 which is PA, and another modifier polymer 502 (herein-after referred to as a second modifier polymer) which is PET, in particular homopolymer PET. The first modifier polymer 402 and the second modifier polymer 502 may each be used in a small amount with a total amount of both the first and the second modifier polymers 402 and 502 not exceeding 10 wt % based on the total polymer material. Hence, because the PET 502 is used in a small amount and is immiscible with both the base polymer 404 and the first modifier polymer 402, the PET also forms domains 408 inside the PA phase 404. In other words, some of the polymer domains 408 are now comprised of the second modifier polymer 502 which is homopolymer PET.

The polymer mixture 500 shown in FIG. 5 is a four-phase system. The four phases are made up of the first modifier polymer 402 (ULDPE and/or LDPE), the base polymer 404 (e.g., PA), the second modifier polymer 502 (e.g., PET), and the compatibilizer 406. The first modifier polymer 402 and the second modifier polymer 502 are not miscible with the base polymer 404. The compatibilizer 406 separates the first modifier polymer 402 from the base polymer 404. The compatibilizer 406 also separates the second modifier polymer 502 from the base polymer 404. In this example the same compatibilizer 406 is used for both the first modifier polymer 402 and the second modifier polymer 502. In other examples different compatibilizers 406 may be used for the first modifier polymer 402 and the second modifier polymer 502. According to some other embodiments, the base polymer 404 is PET and the second modifier polymer 502 is PA.

In some embodiments, the compatibilizer for the first modifier polymer 402 may be EEA and the compatibilizer for the second modifier polymer may be PE-g-MA.

A monofilament, which may also be referred to as a filament or fibrillated tape, is produced by feeding the mixture into a fiber producing extrusion line. The melt mixture is passing the extrusion tool, i.e., a spinneret plate or a wide slot nozzle, forming the melt flow into a filament or tape form, is quenched, or cooled in a water spin bath, dried and stretched by passing rotating heated godets with different rotational speed and/or a heating oven. The monofilament or type is then annealed online in a second step passing a further heating oven and/or set of heated godets.

By this procedure the domains (or bead-like regions) of the modifier polymer are surrounded by the compatibilizer and are stretched into the longitudinal direction and form small fiber like, linear structures dispersed within a continuous polymer matrix of the base polymer.

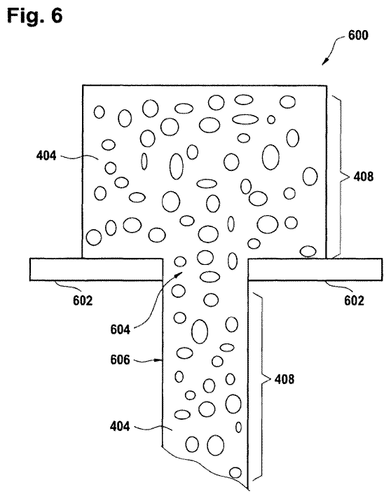

FIG. 6 illustrates an extrusion process for extruding a polymer mixture 600 into a monofilament. The polymer mixture may be the same as the polymer mixture 400 of FIG. 4 or the polymer mixture 500 of FIG. 5. Shown is an amount of polymer mixture 600 comprising a plurality of polymer domains (or bead-like regions) 408. The polymer domains 408 may be made of one or more of the modifier polymers 402 that are not miscible with the base polymer 404. The polymer domains 408 are separated from the base polymer 404 by the compatibilizer 406. Inside the extruder, the polymer mixture 600 is heated to a melt temperature of 220° C. to 280° C., or 220° C. to 250° C. and sheared by a screw or piston to force the polymer mixture 600 through hole 604 of plate 602. The melt temperature used during the extrusion may be modified dependent upon the precise type of polymers and compatibilizer used. This causes the polymer mixture 600 to be extruded into a monofilament 606. The monofilament 606 is shown as containing polymer domains 408 also. The base polymer 404 and the polymer domains 408 are extruded together. In some examples the base polymer 404 will be less viscous than the polymer domains 408 and the polymer domains 408 may tend to concentrate in the center of the monofilament 606. This may lead to desirable properties for the final artificial turf fiber as this may lead to a concentration of the thread-like structures in the core region of the monofilament 606.

The monofilaments may for instance have a diameter of 50-600 micrometer in size. The yarn weight may typically reach 50-3000 dtex.

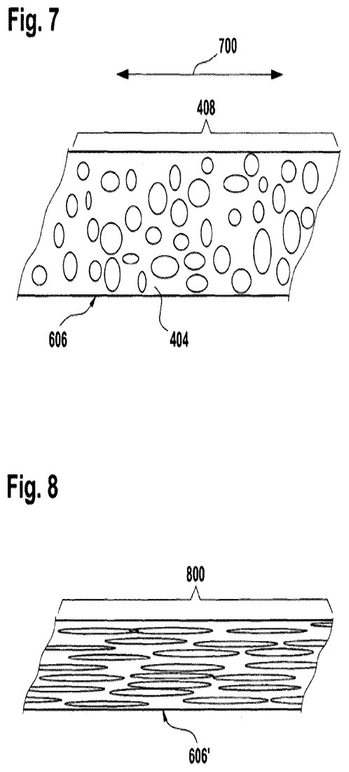

FIG. 7 shows a cross-section of a small segment of the monofilament 606 comprising the base polymer 404 and the polymer domains 408 dispersed within the base polymer 404. The polymer domains 408 are separated from the base polymer 404 by the compatibilizer 406, however, the compatibilizer is not shown in FIG. 7. The thread-like structures are formed by heating a section of the monofilament 606 and then stretching the monofilament 606 in a direction along the length of the monofilament 606. In FIG. 7 the arrows 700 indicate the direction of the stretching of the monofilament 606.

FIG. 8 illustrates the effect of stretching the monofilament 606. In FIG. 8 an example of a cross-section of a stretched monofilament 606′ is shown. The polymer domains 408 in FIG. 7 have been stretched into thread-like structures 800. The degree of reshaping of the polymer domains 408 depends on the extent to which the monofilament 606 has been stretched.

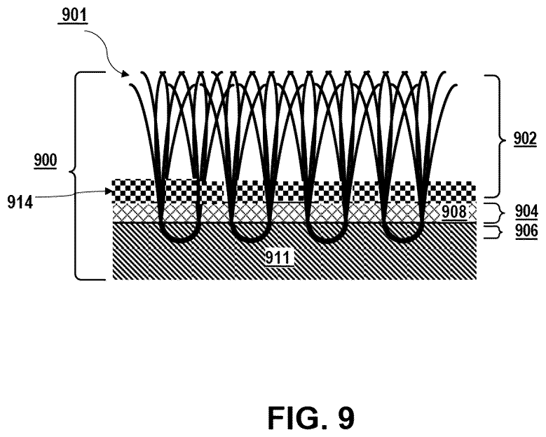

The artificial turf fiber may be used to make artificial turf systems for sports fields such as soccer stadiums or recreational parks, and is particularly suited for applications in hot climate regions. Referring now to FIG. 9, an example of an artificial turf system 900 using the inventive fibers 901 is illustrated. Specifically, the artificial turf system 900 may include the inventive grass-like fibers 901 attached to a backing 908. The fibers may have a first portion 902 extending above the backing 908, a second portion 904 passing through the backing 908 and a third portion 906 extending below the backing 908. The fibers may be made in different lengths, and shapes to mimic natural grass and ensure durability, safety, and performance. The artificial turf system 900 may further comprise an infill material 914 that is spread between the fibers to provide stability, cushioning, and support. The infill may vary. For example, the infill may include at least one of crumb rubber, sand, and organic materials such as olive pits, cork, or coconut husks. Organic materials are preferred because they are more environmentally friendly alternatives. The turf may further comprise the backing 908. The backing 908 may be a layer of woven or non-woven material to which the fibers are attached. An additional coating layer 911 may be added to improve the tuft bind (also referred to sometimes as tensile adhesion). Tuft bind refers to the force needed to pull a tuft of fiber from the backing. The additional coating may be, for example, a polyurethane coating. Additional layers may be optionally used. For example, an additional layer (not shown) may be added underneath the turf that provides shock absorption and reduces the impact on players.

The inventive fiber may exhibit an improved balance of durability and performance characteristics compared to PA fibers, or PA/LLDPE fibers or PA/HDPE fibers.

More specifically, it has been found that the inventive fiber provides an improved balance of softness, and resilience compared to PA fibers, or PA/LLDPE fibers or PA/HDPE fibers. Softness refers to how pliable, smooth, and gentle the synthetic turf blades feel to the touch and underfoot. It affects player comfort and safety, especially for sport surfaces like soccer field surfaces where the player comes into frequent contact with the turf. Resilience is also known to as “bounce back” and refers to the ability of the synthetic turf blades to recover their original shape after being compressed, bent, or deformed.

The inventive fiber also exhibits an improved balance of heat resistance and softness compared to PA fibers, PA/LLDPE, or PA/HDPE fibers. The fibers can withstand the elevated high temperatures of hot climate regions for prolonged periods of time without deforming or weakening. The fibers can maintain their upright position and not sag or soften under high temperatures. The inventive fibers exhibit high heat resistance despite the significant improvement of their softness characteristic.

In addition to the above improved performance characteristics, the inventive fibers also exhibit improved wear resistance compared to PA fibers, PA/LLDPE fibers or PA/HDPE fibers.

Moreover, the inventive fibers are substantially free of the delamination issue encountered with existing composite fibers of PA and PE. Although the precise mechanism preventing delamination is not fully understood, it is postulated that the highly branched nature of the ULDPE and LDPE create much better dispersed, more stable, and practically non-migrating domains inside the PA or PET continuous phase.

Another advantage of the inventive fibers is that they can be made without the use of complicated coextrusion requiring several extrusion heads to feed one complex spinneret tool.

While the invention has been illustrated and described in detail in the drawings and foregoing description, such illustration and description are to be considered illustrative or exemplary and not restrictive; the invention is not limited to the disclosed examples.

### REFERENCE SIGNS LIST

100, 102, 104, 106, 108, process steps
200, 202, 204, 206, process steps
300, 302, 304, 306, 308 process steps
400, 500, 699 polymer mixture
402, 502 modifier polymer
404 base polymer
406 compatibilizer
408 polymer domains
602 plate
604 hole of extruder plate
606 monofilament
700 arrows indicating direction of stretching
800 thread-like structures
900 artificial turf system
901 artificial turf fiber
902 first portion of fibers extending above backing
904 second portion of fibers passing through the backing
906 third portion of fibers extending below the backing
908 the backing of the artificial turf system
914 infill material
911 coating layer

1. An artificial turf fiber comprising:
a modifier polymer material in an amount of 1.0 to 10.0% by weight of the fiber,
the remainder of the fiber including a base polymer material and at least one additive, wherein the modifier polymer material is polyethylene selected from an ultra-low density polyethylene (ULDPE) or a low density polyethylene (LDPE) or a combination thereof,
wherein the base polymer material is polyamide, or polyester, or a combination thereof, and
wherein the at least one additive includes a compatibilizer.

2. The artificial turf fiber of claim 1, wherein the compatibilizer forms a boundary layer between the modifier polymer material and the base polymer material, and wherein the modifier polymer material forms elongated thread-like structures inside a continuous phase of the base polymer material.

3. The artificial turf fiber of claim 1, wherein the compatibilizer includes ethylene ethyl acrylate (“EEA”).

4. The artificial turf fiber of claim 1, wherein the compatibilizer includes
a polyethylene grafted with maleic anhydride or
a combination of polyethylene grafted with maleic anhydride and ethylene ethyl acrylate (“EEA”) or any combination thereof.

5. The artificial turf fiber of claim 4, wherein the polyethylene grafted with maleic anhydride is an ULDPE or LDPE, and more particularly is the same as the polyethylene that is the modifier polymer material.

6. The artificial turf of claim 1, wherein the artificial turf fiber comprises 2.0 to 9.0%, or 2.0 to 8.0%, or 2.0 to 7.0%, or 3.0 to 7.0% of the modifier polymer material.

7. The artificial turf fiber of claim 1, wherein the modifier polymer material is ULDPE.

8. The artificial turf fiber of claim 1, wherein base polymer is one of PA6, PA66, PA11, PA12, PA46, PA610 and PA612, or wherein the base polymer material is polyester homopolymer with a melting point of 160 to 170° C.

9. The artificial turf fiber of claim 1, wherein the compatibilizer is any one of the following: a maleic acid grafted on polyethylene or polyamide; a maleic anhydride grafted on free radical initiated graft copolymer of polyethylene, SEBS, EVA, EPD, or polyproplene with an unsaturated acid or its anhydride such as maleic acid, glycidyl methacrylate, ricinoloxazoline maleinate; a graft copolymer of SEBS with glycidyl methacrylate, a graft copolymer of EVA with mercaptoacetic acid and maleic anhydride; a graft copolymer of EPDM with maleic anhydride; a graft copolymer of polypropylene with maleic anhydride; a polyolefin-graft-polyamide; a polyolefin-graft-polyethylene; a polyolefin-graft-polyamide; a polyacrylic acid type compatibilizer; a polyethylene grafted with maleic anhydride; and ethylene ethyl acrylate, EEA.

10. The artificial turf fiber of claim 1, wherein the compatibilizer is polyethylene grafted with maleic anhydride having a melting point of 105° C.-135° C. as measured by ASTM D3418 or ISO 3146, a crystallization point of 90° C.-110° C. as measured by ASTM D3418, or ISO 3146, a cat softening point of 90° C.-100° C. as measured by ASTM D1525 or ISO 306, a density of 0.80 g/cm3 to 1.00 g/cm3 as measured by ASTM D792 or ISO 1183, and a melt flow index of 1.0-5.0 g/10 min (190° C./2.16 kg), as measured by ASTM D1238 or ISO 1133.

11. The artificial turf fiber of claim 1, wherein a weight percent ratio of the compatibilizer to the modifier polymer material is 2 to 30, or 5 to 20, or 7 to 30.

12. The artificial turf fiber of claim 2, wherein the thread-like structures have a diameter less than 50 micrometers, or less than 10 micrometers, or less than 1 micrometers.

13. The artificial turf fiber of claim 2, wherein the thread-like structures have a length of less than 2 mm.

14. An artificial turf comprising an artificial turf backing, and an artificial turf fiber according to any of the previous claims incorporated into the artificial turf backing.

15. A method of manufacturing an artificial turf fiber, the method comprising the steps of:
creating a polymer mixture, the polymer mixture comprising 1.0 to 10.0 % by its weight a modifier polymer material, the remainder of the polymer mixture including a base polymer material and at least one additive, wherein the modifier polymer material is polyethylene selected from an ultra-low density polyethylene (ULDPE) or a low density polyethylene (LDPE) or a combination thereof, wherein the base polymer material is polyamide, or polyester, or a blend of the polyamide and the polyester, wherein the at least one additive includes a compatibilizer, wherein the polymer mixture comprises domains of the modifier polymer material;
extruding the polymer mixture into a monofilament;
quenching the monofilament;
reheating the monofilament; and
stretching the reheated monofilament to reshape the domains of the modifier polymer into threadlike structures and to form the monofilament into an artificial turf fiber;

16. The method of claim 15, wherein the compatibilizer comprises a polyethylene grafted with maleic anhydride or ethylene ethyl acrylate EEA or a combination thereof, wherein the modifier polymer material and the base polymer material are immiscible and the modifier polymer material domains are surrounded by a boundary layer of the compatibilizer and are within a continuous phase of the base polymer material; wherein the polymer domains comprise crystalline fractions and amorphous fractions, and wherein stretching the polymer domains into thread-like structures causes an increase in the size of the crystalline fractions relative to the amorphous fractions.

17. The method of claim 15, wherein the creating of the polymer mixture comprises the steps of:
forming a first mixture by mixing the modifier polymer material with the compatibilizer;
heating and extruding the first mixture;
granulating the extruded first mixture;
mixing and heating the granulated first mixture with the base polymer material to form the polymer mixture.

18. A method for making artificial turf, the method comprising incorporating the artificial turf fiber of claim 1 into an artificial turf backing.
